(19) United States
(12) Patent Application Publication
(10) Pub. No.: US 2024/0428022 A1
(43) Pub. Date: Dec. 26, 2024

(54) GRADUAL GRADIENT-BASED PRUNING FOR MULTILINGUAL NEURAL MACHINE TRANSLATION

(71) Applicant: Zoom Video Communications, Inc., San Jose, CA (US)

(72) Inventors: Thanh-Le Ha, Karlsruhe (DE); Dan He, Stutensee (DE); Minh-Quang Pham, Karlsruhe (DE); Marco Turchi, Pergine Valsugana (IT)

(73) Assignee: Zoom Video Communications, Inc., San Jose, CA (US)

(21) Appl. No.: 18/627,022

(22) Filed: Apr. 4, 2024

Related U.S. Application Data
(60) Provisional application No. 63/521,268, filed on Jun. 15, 2023.

(51) Int. Cl. G06F 40/58; G06F 40/47

(52) U.S. Cl. CPC G06F 40/58; G06F 40/47

(57) ABSTRACT

Systems and methods are disclosed for gradual and/or gradient-based pruning for language-specific multilingual neural machine translation. For example, a method may include determining a pruning mask for weights of a multilingual machine translation model based on a first pruning threshold, wherein the pruning mask includes at least one entry set to zero and at least one entry set to one; training the multilingual machine translation model, while applying the pruning mask to the multilingual machine translation model, for translation between a language pair based on training examples from a bilingual translation corpus; updating the pruning mask based on a second pruning threshold; and training the multilingual machine translation model, while applying the updated pruning mask to the multilingual machine translation model, for translation between the language pair based on training examples from the bilingual translation corpus. For example, the weights may be pruned based on gradient-based scores.

### CROSS-REFERENCE TO RELATED APPLICATIONS

This application claims the benefit of U.S. Provisional Application No. 63/521,268, filed on Jun. 15, 2023, which is incorporated herein by reference in its entirety.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a flowchart of an example of a technique for gradual pruning for multilingual neural machine translation.

FIG. 5 is a flowchart of an example of a technique for gradient-based pruning for multilingual neural machine translation.

FIG. 6 is a listing of pseudo-code illustrating an example of a technique for gradient-based pruning for multilingual neural machine translation.

### DETAILED DESCRIPTION

Systems and methods are disclosed for gradual and/or gradient-based pruning for language-specific multilingual neural machine translation. A method may include determining a pruning mask for weights of a multilingual machine translation model based on a first pruning threshold. The multilingual machine translation model is trained, while applying the pruning mask to the multilingual machine translation model, for translation between a language pair based on training examples from a bilingual translation corpus. The pruning mask is updated based on a second pruning threshold. The multilingual machine translation model is trained, while applying the updated pruning mask to the multilingual machine translation model, for translation between the language pair based on training examples from the bilingual translation corpus. For example, the weights may be pruned based on gradient-based scores.

Multilingual neural machine translation (MNMT) offers the convenience of translating between multiple languages with a single model. However, compared to bilingual counterparts, MNMT often suffers from performance degradation in high-resource languages. This degradation is commonly attributed to negative interference, which occurs when all parameters are fully shared across languages. Implementations described herein mitigate this issue by using gradient-based gradual pruning for language-specific MNMT. For example, a unique subnetwork for each language pair may first be extracted by pruning the MNMT model using gradient-based information. During pruning, the pruning ratio may be increased gradually from zero to a target level. Then extracted sub-networks may be incorporated into the MNMT model, allowing the system to capture language-specific information. Some implementations may achieve notable performance gain over conventional multilingual translation systems on test data sets.

In recent years, neural machine translation (NMT) based on the transformer architecture has achieved great success and become the dominant paradigm for machine translation. Multilingual neural machine translation (MNMT), which learns a unified model to translate between multiple languages, has attracted growing attention in the NMT area. The reasons are: 1) From a practical perspective, it significantly reduces the training and inference cost and simplifies deployment in production; 2) Utilizing data from multiple language pairs simultaneously can potentially help improve the translation quality of low-resource or even zero-resource language pairs by transferring knowledge across languages.

Despite these benefits, multilingual NMT remains challenging as it tends to suffer from performance degradation compared to its bilingual counterparts, especially for high-resource translation directions. Prior work attributes this performance degradation to limited multilingual NMT model capacity and negative interference. Although naively increasing model size may lead to better performance, large models often suffer from parameter inefficiency and overfitting without solving the negative interference issue.

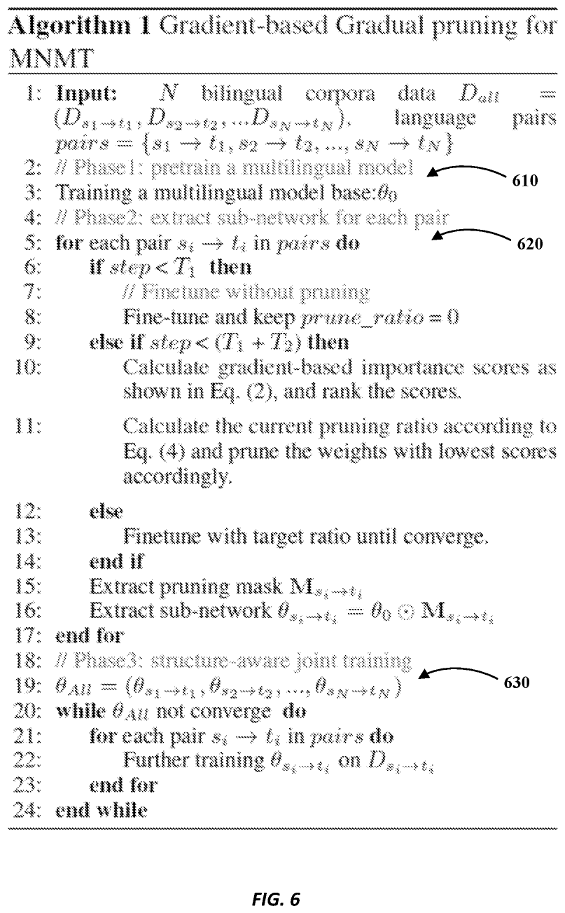

Some implementations include three main phases. In the first one (Phase1 in Algorithm 1 illustrated in FIG. 6), a multilingual model is initially trained using the negative log-likelihood loss. Subsequently, the multilingual base model is simultaneously finetuned and pruned on each language pair (Phase2 in Algorithm 1 illustrated in FIG. 6). In this phase, we adopt the gradient-based pruning criterion as the scoring function for each weight and the gradual pruning mechanism to identify sub-network masks for language pairs. The extracted masks are then jointly used during the final training (Phase3 in Algorithm 1 illustrated in FIG. 6).

### Multilingual Neural Machine Translation

Some implementations use a multilingual transformer as the backbone of an NMNT. For example, a unified model for multilingual NMT may be used by adding two language tokens to indicate source and target languages. Given a set of N bilingual corpora, the multilingual model is jointly trained over the set of all N parallel training corpora. The objective may be to minimize the negative log-likelihood of the target sentence given the source sentence over all corpora. The training loss may be formulated as follows:

$${L}_{MT} = - {\sum }_{i = 1}^{N} {\sum }_{j = 1}^{J} log p ( {y}_{i , j} \vert {y}_{i , < j} , X \text{?} , θ ) \qquad Equation 1$$

$$where$$

$${X}_{i} = ( {x}_{i , 1} , {x}_{i , 2} , … , {x}_{i , l} )$$

$$and$$

$$Y = ( {y}_{i , 1} , {y}_{i , 2} , … , {y}_{i , j} )$$

$$\text{?} \text{indicates text missing or illegible when filed}$$

represent the source and target sentences of one sentence pair in the parallel corpus Dₛ_{ᵢ}_{→t}_{ᵢ} respectively, with source sentence length I and target sentence length J. The index of the current target word is denoted by j, which ranges from 1 to the sentence length J. θ represents the model parameters.

### Identify Sub-Networks Via Pruning

Once the MNMT model is trained, sub-networks are identified by applying a pruning approach. For example, in a gradient-based pruning criterion, an importance score for each weight in the model is first learned and then the model is pruned based on these importance scores during the joint finetuning and pruning process. The importance scores can be represented as follows:

$${S}_{i , j}^{( T )} = - {\sum }_{t < T} {( \frac{\partial L}{\partial {W}_{i , j}} )}^{( t )} {W}_{i , j}^{( t )} \qquad Equation 2$$

$$where$$

$$\frac{\partial L}{\partial {W}_{i , j}}$$

where is the gradient of loss L with respect to W_{i,j} in a generic weight matrix W∈ [symbol] ^{M×N} of the model, T denotes the number of performed gradient updates, S_{i,j}^{(T)} denotes the importance score of weight W_{i,j} after T updates.

After scoring each weight using Equation 2 and ranking the score values, we prune the weights having importance scores among the v % lowest, regardless of the absolute score values. To this end, a binary mask matrix M∈{0, 1}^{M×N} based on the importance scores is calculated as follows:

$${M}_{i , j} = \{ \begin{matrix}0 & {S}_{i , j} among v \% lowest scores \\ 1 , & otherwise\end{matrix} \qquad Equation 3$$

In some implementations, weights with scores among the lowest v % are assigned a value of 0 in the binary mask matrix and pruned, while the other weights are assigned a value of 1 in the mask and retained. Masks for each matrix in the model may be calculated and used to extract the sub-networks for each language pair: θₛ_{ᵢ}_{→t}_{ᵢ}=θ₀⊙Mₛ_{ᵢ}_{→t}_{ᵢ}. Where ⊙ denotes the Hadamard product, sᵢ→tᵢ is the language pair, Mₛ_{ᵢ}_{→t}_{ᵢ}∈{0, 1}^{|θ|} represents the mask of the entire model for pair sᵢ→tᵢ, θ₀ denotes the initial model, and θₛ_{ᵢ}_{→t}_{ᵢ} represents the corresponding sub-network for the pair sᵢ→tᵢ.

A gradual pruning mechanism may be used. For example, a pruning ratio may be gradually increased from 0 to a target value through a three-stage process (Phase2 in Algorithm 1 shown in FIG. 6), as outlined in the following equation:

$${R}_{t} = \{ \begin{matrix}0 & t < {T}_{1} \\ {R}_{p} - {{R}_{p} ( 1 - \frac{t - {T}_{1}}{{T}_{2}} )}^{3} & {T}_{1} < t < ( {T}_{1} + {T}_{2} ) \\ {R}_{p} & otherwise\end{matrix} \qquad Equation 4$$

where t represents the current training step, Rₜ represents the pruning ratio at step t, Rₚ represents the preset target pruning ratio, T₁ and T₂ represent the total steps of stage 1 and stage 2, respectively.

In the first stage spanning T₁ training steps, the model remains unpruned with a pruning ratio of 0. In the second stage, which lasts for T₂ training steps, the pruning ratio gradually increases from 0 until the predefined threshold Rₚ. In the third stage, the pruning ratio remains constant at the target pruning ratio Rₚ.

### Joint Training

In some implementations, once the sub-networks θₛ_{ᵢ}_{→t}_{ᵢ}, i=1, . . . ,N for all language pairs are obtained, the multilingual base model θ₀ is further trained with language-aware data batching and structure-aware model updating. For example, batches of each language pair may be randomly grouped from the language-specific bilingual corpus. Given a pair sᵢ→tᵢ, batches Bₛ_{₁}_{→t}_{₁} for this pair may be randomly grouped from the bilingual corpus Dₛ_{ᵢ}_{→t}_{ᵢ}. Importantly, each batch contains samples from a single language pair, which differs from plain joint multilingual training where each batch can contain fully random sentence pairs from all language pairs. The model may be trained iteratively on batches of all language pairs until convergence. During backpropagation, only parameters in the sub-network of the corresponding language pair are updated. During inference, the sub-network corresponding to the specific language pair is utilized to generate predictions. Notably, the sub-networks of all language pairs may be accommodated in a single model, without introducing any additional parameters.

### Model Settings

Models of different sizes may be utilized to adjust for the variation in dataset sizes. In one example, for a smaller size dataset (e.g., from the International Conference on Spoken Language Translation (IWSLT) benchmark), a smaller transformer (e.g., Transformer-small) may be used. For example, given the small scale of the data in the IWSLT dataset, the Transformer-small architecture with 4 attention heads: L=6, d=512, n head=4 and dff=1024 may be used. For a larger size dataset (e.g., from the Workshop on Statistical Machine Translation (WMT)), a larger transformer (e.g., Transformer-base) may be used. In some implementations, the pruning approach is only applied to two linear sub-layers: attention and/or feed-forward. For example, given the WMT dataset, the Transformer-base architecture with 8 attention heads: L=6, d=512, n head=8 and dff=2048 may be used. However, it should be appreciated that these parameters may be tuned appropriately for data sets of different sizes.

### Training Details

As discussed above training may include three phases: training multilingual base model, identifying sub-networks through pruning, and joint training. In this section, examples of details of hyperparameters of these 3 phases are provided.

In a first example using an IWSLT dataset, a multilingual base model may be trained using the following the settings: (β1=0.9, β2=0.98), a learning rate schedule of (5e-4,4k), dropout of 0.1 and label smoothing of 0.1. The max tokens per batch may be set to 262144. The maximum update number may be set to 160K with a checkpoint saved every 500 updates, and the patience for early stop training may be set to 30. For Phase 2, the max tokens may be set to 16384, and dropout to 0.3. The training steps of 3 stages may be set to 4K, 36K and 40K with patience for early stopping set to 30 in stage3. For example, good performance of the final model may be achieved with a pruning ratio of 0.6 in this phase. The other settings may be the same as in phase1. For Phase 3, the same settings as Phase 1 may be used with the exception that masks are applied on the model.

In a first example using a WMT dataset, a multilingual base model may be trained using the following the settings: (β1=0.9, β2=0.98), a learning rate schedule of (5e-4,4k), dropout of 0.1 and label smoothing of 0.1. The max tokens per batch may be set to 524288. The maximum update number may be set to 600K with a checkpoint saved every 1K updates, and the patience for early stop training may be set to 30. For Phase 2, the max tokens per batch may be set to 20K, 40K, 80K, and 160K for languages with training data sizes >10K, >100K, >1M, and >10M. The training steps of 3 stages are set to 4K, 16K and 20K with patience for early stopping set to 30 in stage3. For example, good performance of the final model may be achieved with a pruning ratio of 0.2 in this phase. For Phase 3, the same settings as Phase 1 may be used with the exception that masks are applied on the model. And while this example employed these particular settings, it should be appreciated that these particular values are not required and instead, they may be adjusted as needed according to different examples.

### Gradient-Based Pruning Criterion

In some implementations gradient-based pruning is applied to MNMT. This approach uses gradient-based information to identify the language-specific sub-networks. More specifically, to identify which weights to prune in a given weight matrix W, a score matrix S and a binary mask matrix M are introduced in association with the weight matrix. Each parameter in the score matrix is intended to capture and learn the importance of the corresponding weight, and each element in the binary mask is assigned a value of either 0 or 1 according to whether the corresponding weight is pruned or retained. Weights with relatively low scores in the score matrix are considered less important and assigned a value of 0 in the binary mask matrix. Score parameters may be learned and updated iteratively during the training process. The scores of all the weights, both pruned and retained weights, may be updated. The updating of scores can change the relative importance of different weights and affect their score distribution. This process enables the model to self-correct by allowing pruned weights to come back.

In the following demonstration, the learned scores are based on gradient information, as depicted in Equation 2. In the forward pass of the training process, the masking step, where the output is 1 if the input (in this context, the score) is above a threshold and 0 otherwise, is performed after the linear operation. The output of the linear operation and masking can be calculated as aᵢ=Σₖ₌₁^{N} W_{i,k}M_{i,k}xk. During backpropagation, the gradients of learnable parameters may be computed to update these parameters and facilitate the learning process. However, the masking step, introduces a non-differentiable behavior at the threshold point. Besides, the constant output of 1 or 0 results in a gradient of 0 everywhere it is defined. This can lead to the so-called “vanishing gradient” issue, which arises when the gradients become very small or vanish at some point during backpropagation. As a result, the flow of useful gradient information is hindered, making it difficult to train the model effectively. This issue may be mitigated by employing straight-through estimator. More specifically, during backpropagation, the masking step may be ignored and the gradient after the masking step flows “straight-through” to the step before the masking step. As a result, the gradient of loss L with respect to N and Vi can be calculated as in Equations 5 and 6, respectively.

$$\frac{\partial L}{\partial {S}_{i , j}} = \frac{\partial L}{\partial \text{?}} \frac{\partial \text{?}}{\partial {S}_{i , j}} = \frac{\partial L}{\partial \text{?}} {W}_{i , j} {x}_{j} \qquad Equation 5$$

$$\frac{\partial L}{\partial {W}_{i , j}} = \frac{\partial L}{\partial \text{?}} \frac{\partial \text{?}}{\partial {W}_{i , j}} = \frac{\partial L}{\partial \text{?}} {M}_{i , j} {x}_{j} \qquad Equation 6$$

$$\text{?} \text{indicates text missing or illegible when filed}$$

It follows from Equation 6 that

$$\frac{\partial L}{\partial {α}_{i}} = \frac{\partial L}{\partial {W}_{i , j}} \frac{1}{{M}_{i , j}} \frac{1}{{x}_{j}} .$$

By omitting the binary mask term M_{i,j}, it follows that

$$\frac{\partial L}{\partial {α}_{i}} = \frac{\partial L}{\partial {W}_{i , j}} \frac{1}{{x}_{j}} .$$

Inserting the obtained result of ∂L/∂aᵢ into Equation 5 yields

$$\frac{\partial L}{\partial {S}_{i , j}} = \frac{\partial L}{\partial {W}_{i , j}} \frac{1}{{x}_{j}} {W}_{i , j} {x}_{j} .$$

Therefore, the gradient of L with respect to S_{i,j} can be represented as

$$\frac{\partial L}{\partial {S}_{i , j}} = \frac{\partial L}{\partial {W}_{i , j}} {W}_{i , j} .$$

The importance score after T gradient updates can be represented as:

$${S}_{i , j}^{( T )} = - {α}_{i} \sum \text{?} ( \frac{\partial L}{\partial {W}_{i , j}} ) \text{?} W \text{?}$$

$$\text{?} \text{indicates text missing or illegible when filed}$$

where T denotes the number of gradient updates, aᵢ is the learning rate during training process. A specific percentage of weights may be pruned based on the distribution of importance score values, regardless of the absolute score values. The learning rate aᵢ, which remains constant across all score parameters, does not impact the distribution and can be disregarded for simplicity without affecting the pruning outcome, as shown in Equation 2.

In some implementations, a gradient-based pruning criterion is applied in an MNMT. In some implementations, a gradual pruning mechanism is applied. In some implementations, a gradient-based pruning criterion and a gradual pruning mechanism are combined in a Gradient-Gradual approach.

Systems and methods described herein may provide advantages over conventional systems for automated multilingual translation. In a standard MNMT model, the parameters are shared across all language pairs, which may result in a negative interference issue and compromised performance. A gradient-based gradual pruning for a multilingual translation approach may be used to identify optimal sub-networks and mitigate the interference issue. In some scenarios, this approach may achieve significant performance gains over a normal MNMT system and yield better performance and stability than other approaches. The interference issue can be more severe in attention sublayers and it is possible to reconstruct a reliable phylogenetic tree of languages using the language-specific sub-networks generated by a gradient-based gradual pruning approach.

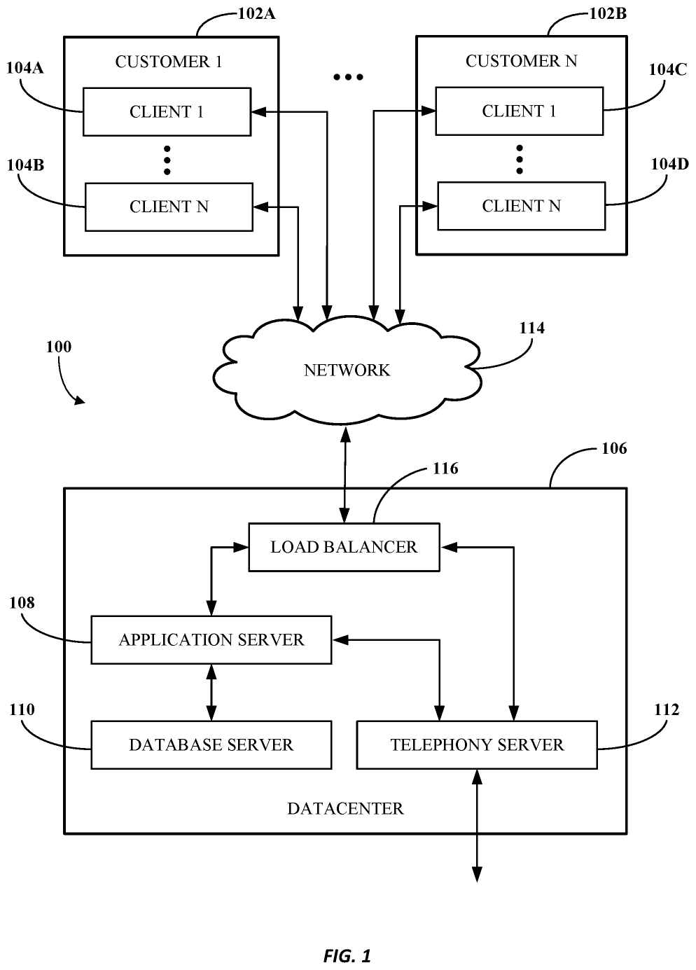

To describe some implementations in greater detail, reference is first made to examples of hardware and software structures used to implement language-specific multilingual neural machine translation. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. Datacenters may be spread across various geographical locations. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application servers 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and to clients of a customer, such as the clients 104A through 104B for the customer 102A or the clients 104C through 104D for the customer 102B. Some or all of the clients 104A through 104D may be voice over internet protocol (VOIP)-enabled devices configured to send and receive calls over a network 114. In particular, the telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

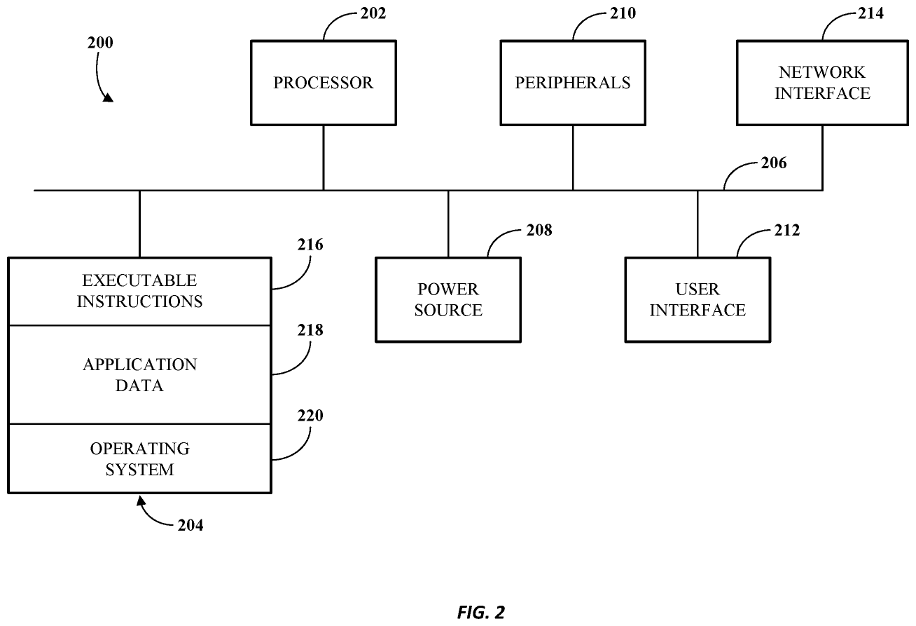

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

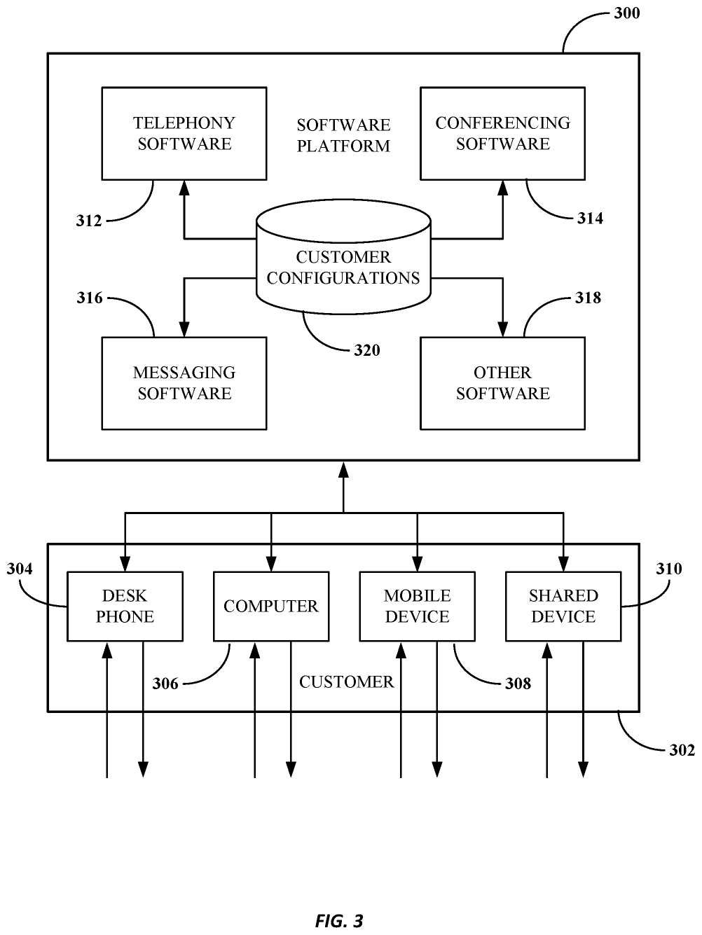

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients—a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include software for language-specific multilingual neural machine translation of data (e.g., conference transcripts) in the software platform 300.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

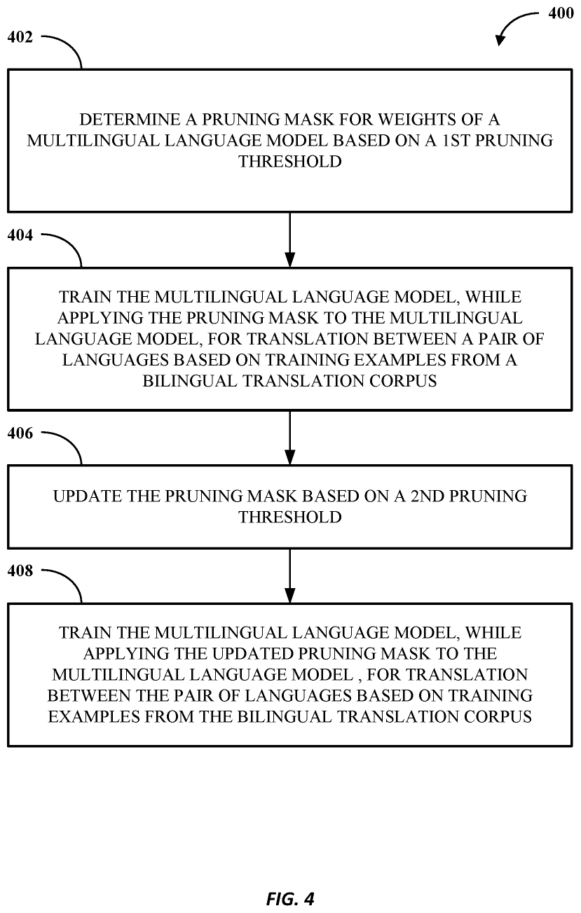

FIG. 4 is a flowchart of an example of a technique 400 for gradual pruning for multilingual neural machine translation. The technique 400 can be executed using computing devices, such as the systems, hardware, and software described with respect to FIGS. 1-3. The technique 400 can be performed, for example, by executing a machine-readable program or other computer-executable instructions, such as routines, instructions, programs, or other code. The steps, or operations, of the technique 400 or another technique, method, process, or algorithm described in connection with the implementations disclosed herein can be implemented directly in hardware, firmware, software executed by hardware, circuitry, or a combination thereof.

For simplicity of explanation, the technique 400 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

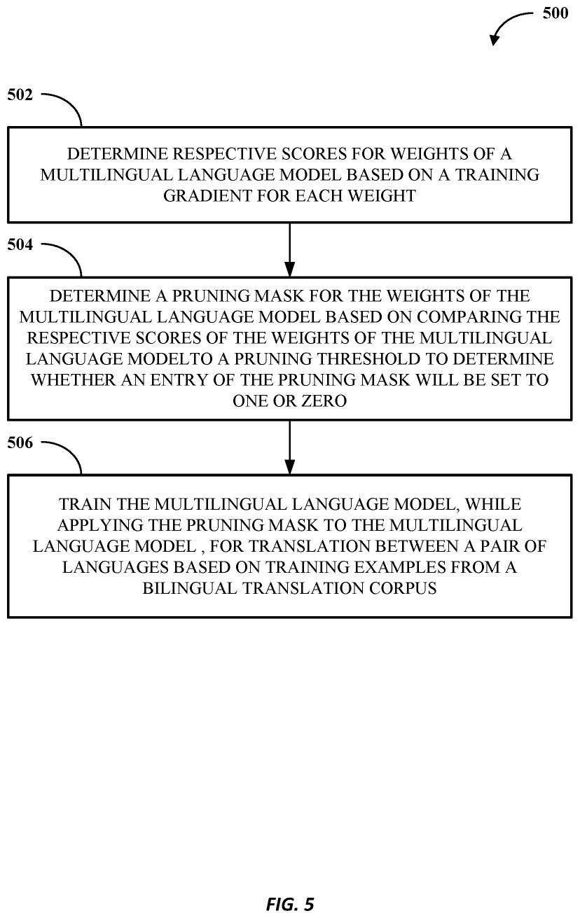

At 402, the technique 400 includes determining a pruning mask for weights of a multilingual machine translation model based on a first pruning threshold, wherein the pruning mask includes at least one entry set to zero and at least one entry set to one. For example, the multilingual machine translation model may include a transformer network (e.g., Transformer-small or Transformer-base). In some implementations, the multilingual machine translation model has been pre-trained using a multilingual translation corpus as described in Phase 1 (610) of the algorithm illustrated in FIG. 6. For example, the pruning mask may be the binary matrix described in Equation 3. In some implementations, determining the pruning mask includes comparing magnitudes of the weights of the multilingual machine translation model to the first pruning threshold to determine whether an entry of the pruning mask will be set to one or zero. In some implementations, determining the pruning mask includes determining respective scores for the weights of the multilingual machine translation model based on a training gradient for each weight; and comparing the respective scores of the weights of the multilingual machine translation model to the first pruning threshold to determine whether an entry of the pruning mask will be set to one or zero. For example, the technique 500 of FIG. 5 may be implemented to determine the pruning mask for weights of the multilingual machine translation model based on the first pruning threshold. In some implementations, the respective score of a weight of the multilingual machine translation model is determined based on a product of the training gradient for the weight and the weight. For example, the respective scores of weights of the multilingual machine translation model may be determined using Equation 2. The pruning mask may be applied to a subset of the parameters of the multilingual machine translation model, rather than to all of its trained parameters. In some implementations, the pruning approach is only applied to two linear sub-layers: attention and/or feed-forward, and the matrix only has elements corresponding to parameters of these sub-layers.

At 404, the technique 400 includes training the multilingual machine translation model, while applying the pruning mask to the multilingual machine translation model, for translation between a language pair based on training examples from a bilingual translation corpus. For example, the pruning mask may be applied when training with a bilingual translation corpus for translations from English to German or any other translation pairing. The pruning mask may be specific to the language pair. In some implementations multiple pruning mask are determined for use when training with different respective bilingual translation corpuses. For example, training loss may be determined using Equation 1.

At 406, the technique 400 includes updating the pruning mask based on a second pruning threshold. In some implementations, the technique 400 includes determining the first pruning threshold based on a first pruning ratio that specifies a proportion of the weights of the multilingual machine translation model to be zeroed; and determining the second pruning threshold based on a second pruning ratio that specifies a proportion of the weights of the multilingual machine translation model to be zeroed. For example, the first pruning ratio and the second pruning ratio may be interpolated between zero and a target pruning ratio based on a count of iterations of training and updating the pruning mask. For example, a pruning ratio used to change a pruning threshold to update the pruning mask may be determined using Equation 4.

At 408, the technique 400 includes training the multilingual machine translation model, while applying the updated pruning mask to the multilingual machine translation model, for translation between the language pair based on training examples from the bilingual translation corpus. In some implementations, the technique 400 may be continued iteratively to update the pruning mask using new pruning thresholds and train using the updated pruning mask until a target pruning ratio is achieved. For example, the technique 400 may be continued iteratively as described in Phase 2 (620) of the algorithm illustrated in FIG. 6.

The technique 400 may be applied for multiple language pairs in a multilingual translation corpus. In some implementations, the language pair is a first language pair, the pruning mask is a first pruning mask, and the technique 400 further includes determining a second pruning mask for the weights of the multilingual machine translation model based on a third pruning threshold, wherein the second pruning mask includes at least one entry set to zero and at least one entry set to one; training the multilingual machine translation model, while applying the second pruning mask to the multilingual machine translation model, for translation between a second language pair based on training examples from a second bilingual translation corpus; updating the second pruning mask based on a fourth pruning threshold; and training the multilingual machine translation model, while applying the updated second pruning mask to the multilingual machine translation model, for translation between the second language pair based on training examples from the second bilingual translation corpus. For example, the technique 400 may be repeated for each language pair in a multilingual translation corpus as described in Phase 2 (620) of the algorithm illustrated in FIG. 6.

FIG. 5 is a flowchart of an example of a technique 500 for gradient-based pruning for multilingual neural machine translation. The technique 500 can be executed using computing devices, such as the systems, hardware, and software described with respect to FIGS. 1-3. The technique 500 can be performed, for example, by executing a machine-readable program or other computer-executable instructions, such as routines, instructions, programs, or other code. The steps, or operations, of the technique 500 or another technique, method, process, or algorithm described in connection with the implementations disclosed herein can be implemented directly in hardware, firmware, software executed by hardware, circuitry, or a combination thereof.

For simplicity of explanation, the technique 500 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 502, the technique 500 includes determining respective scores for weights of a multilingual machine translation model based on a training gradient for each weight. For example, the multilingual machine translation model may include a transformer network (e.g., Transformer-small or Transformer-base). In some implementations, the multilingual machine translation model has been pre-trained using a multilingual translation corpus as described in Phase 1 (610) of the algorithm illustrated in FIG. 6. In some implementations, the respective score of a weight of the multilingual machine translation model is determined based on a product of the training gradient for the weight and the weight. For example, the respective scores of weights of the multilingual machine translation model may be determined using Equation 2. For example, a training gradient for each weight may be determined using Equation 5 and Equation 6.

At 504, the technique 500 includes determining a pruning mask for the weights of the multilingual machine translation model based on comparing the respective scores of the weights of the multilingual machine translation model to a pruning threshold to determine whether an entry of the pruning mask will be set to one or zero. For example, the pruning mask may be the binary matrix. For example, the pruning mask for the weights of the multilingual machine translation model may be determined using Equation 3. The pruning mask may be applied to a subset of the parameters of the multilingual machine translation model, rather than to all of its trained parameters. In some implementations, the pruning approach is only applied to two linear sub-layers: attention and/or feed-forward, and the matrix only has elements corresponding to parameters of these sub-layers.

At 506, the technique 500 includes training the multilingual machine translation model, while applying the pruning mask to the multilingual machine translation model, for translation between a language pair based on training examples from a bilingual translation corpus. For example, the pruning mask may be applied when training with a bilingual translation corpus for translations from French to English or any other translation pairing. The pruning mask may be specific to the language pair. In some implementations, multiple pruning masks are determined for use when training with different respective bilingual translation corpora. For example, training loss may be determined using Equation 1.

FIG. 6 is a listing of pseudo-code illustrating an example of a technique 600 for gradual gradient-based pruning for multilingual neural machine translation. The technique 600 includes three phases. In a first phase 610, a multilingual translation model is pre-trained using a multilingual translation corpus including N bilingual translation corpora. In a second phase 620, sub-network for each of the N language pairs is extracted using gradual gradient-based pruning. A pruning ratio used to determine a pruning mask for weights of the multilingual translation model is gradually increased between zero and a target pruning ratio, as the multilingual translation model is trained (e.g., finetuned) at step of the iteration using the pruning mask with training data from the bilingual translation corpus for the language pair associated with the pruning mask. The final pruning mask for a language pair at the end of its iteration may be used extract a sub-network from the multilingual translation model for the language pair. In a third phase 630, joint training of the multilingual translation model is performed. For example, batches of each language pair may be randomly grouped from the language-specific bilingual corpus. Each batch may contain samples from a single language pair, which differs from plain joint multilingual training where each batch can contain fully random sentence pairs from all language pairs. The model may be trained iteratively on batches of all language pairs until convergence. In some implementations, during backpropagation, only parameters in the sub-network of the corresponding language pair are updated. During inference, the sub-network corresponding to a specific language pair may be utilized to generate predictions.

One aspect of this disclosure is a method including determining a pruning mask for weights of a multilingual machine translation model based on a first pruning threshold, wherein the pruning mask includes at least one entry set to zero and at least one entry set to one; training the multilingual machine translation model, while applying the pruning mask to the multilingual machine translation model, for translation between a language pair based on training examples from a bilingual translation corpus; updating the pruning mask based on a second pruning threshold; and training the multilingual machine translation model, while applying the updated pruning mask to the multilingual machine translation model, for translation between the language pair based on training examples from the bilingual translation corpus. In this aspect, the method may include determining the first pruning threshold based on a first pruning ratio that specifies a proportion of the weights of the multilingual machine translation model to be zeroed; and determining the second pruning threshold based on a second pruning ratio that specifies a proportion of the weights of the multilingual machine translation model to be zeroed. In this aspect, the first pruning ratio and the second pruning ratio may be interpolated between zero and a target pruning ratio based on a count of iterations of training and updating the pruning mask. In this aspect, determining the pruning mask may include comparing magnitudes of the weights of the multilingual machine translation model to the first pruning threshold to determine whether an entry of the pruning mask will be set to one or zero. In this aspect, determining the pruning mask may include determining respective scores for the weights of the multilingual machine translation model based on a training gradient for each weight; and comparing the respective scores of the weights of the multilingual machine translation model to the first pruning threshold to determine whether an entry of the pruning mask will be set to one or zero. In this aspect, the respective score of a weight of the multilingual machine translation model may be determined based on a product of the training gradient for the weight and the weight. In this aspect, the language pair may be a first language pair, the pruning mask may be a first pruning mask, and the method may include determining a second pruning mask for the weights of the multilingual machine translation model based on a third pruning threshold, wherein the second pruning mask includes at least one entry set to zero and at least one entry set to one; training the multilingual machine translation model, while applying the second pruning mask to the multilingual machine translation model, for translation between a second language pair based on training examples from a second bilingual translation corpus; updating the second pruning mask based on a fourth pruning threshold; and training the multilingual machine translation model, while applying the updated second pruning mask to the multilingual machine translation model, for translation between the second language pair based on training examples from the second bilingual translation corpus. For example, this aspect could be implemented using other software 318 running on the application server 108.

One aspect of this disclosure is a system, including a processor and a memory, wherein the memory stores instructions executable by the processor to determine a pruning mask for weights of a multilingual machine translation model based on a first pruning threshold, wherein the pruning mask includes at least one entry set to zero and at least one entry set to one; train the multilingual machine translation model, while applying the pruning mask to the multilingual machine translation model, for translation between a language pair based on training examples from a bilingual translation corpus; update the pruning mask based on a second pruning threshold; and train the multilingual machine translation model, while applying the updated pruning mask to the multilingual machine translation model, for translation between the language pair based on training examples from the bilingual translation corpus. In this aspect, the memory may store instructions executable by the processor to determine the first pruning threshold based on a first pruning ratio that specifies a proportion of the weights of the multilingual machine translation model to be zeroed; and determine the second pruning threshold based on a second pruning ratio that specifies a proportion of the weights of the multilingual machine translation model to be zeroed. In this aspect, the first pruning ratio and the second pruning ratio may be interpolated between zero and a target pruning ratio based on a count of iterations of training and updating the pruning mask. In this aspect, the memory may store instructions executable by the processor to compare magnitudes of the weights of the multilingual machine translation model to the first pruning threshold to determine whether an entry of the pruning mask will be set to one or zero. In this aspect, the memory may store instructions executable by the processor to determine respective scores for the weights of the multilingual machine translation model based on a training gradient for each weight; and compare the respective scores of the weights of the multilingual machine translation model to the first pruning threshold to determine whether an entry of the pruning mask will be set to one or zero. In this aspect, the respective score of a weight of the multilingual machine translation model may be determined based on a product of the training gradient for the weight and the weight. In this aspect, the language pair may be a first language pair, the pruning mask may be a first pruning mask, and the memory may store instructions executable by the processor to determine a second pruning mask for the weights of the multilingual machine translation model based on a third pruning threshold, wherein the second pruning mask includes at least one entry set to zero and at least one entry set to one; train the multilingual machine translation model, while applying the second pruning mask to the multilingual machine translation model, for translation between a second language pair based on training examples from a second bilingual translation corpus; update the second pruning mask based on a fourth pruning threshold; and train the multilingual machine translation model, while applying the updated second pruning mask to the multilingual machine translation model, for translation between the second language pair based on training examples from the second bilingual translation corpus. For example, this aspect could include the processor 202 and the memory 204, which may be components of the application server 108.

One aspect of this disclosure is a non-transitory computer-readable storage medium, comprising executable instructions that, when executed by a processor, facilitate performance of operations, including determining a pruning mask for weights of a multilingual machine translation model based on a first pruning threshold, wherein the pruning mask includes at least one entry set to zero and at least one entry set to one; training the multilingual machine translation model, while applying the pruning mask to the multilingual machine translation model, for translation between a language pair based on training examples from a bilingual translation corpus; updating the pruning mask based on a second pruning threshold; and training the multilingual machine translation model, while applying the updated pruning mask to the multilingual machine translation model, for translation between the language pair based on training examples from the bilingual translation corpus. In this aspect, the operations may include determining the first pruning threshold based on a first pruning ratio that specifies a proportion of the weights of the multilingual machine translation model to be zeroed; and determining the second pruning threshold based on a second pruning ratio that specifies a proportion of the weights of the multilingual machine translation model to be zeroed. In this aspect, the first pruning ratio and the second pruning ratio may be interpolated between zero and a target pruning ratio based on a count of iterations of training and updating the pruning mask. In this aspect, determining the pruning mask may include comparing magnitudes of the weights of the multilingual machine translation model to the first pruning threshold to determine whether an entry of the pruning mask will be set to one or zero. In this aspect, determining the pruning mask may include determining respective scores for the weights of the multilingual machine translation model based on a training gradient for each weight; and comparing the respective scores of the weights of the multilingual machine translation model to the first pruning threshold to determine whether an entry of the pruning mask will be set to one or zero. In this aspect, the respective score of a weight of the multilingual machine translation model may be determined based on a product of the training gradient for the weight and the weight. For example, this aspect could include other software 318 accessed by the application server 108.

One aspect of this disclosure is a method including determining respective scores for weights of a multilingual machine translation model based on a training gradient for each weight; determining a pruning mask for the weights of the multilingual machine translation model based on comparing the respective scores of the weights of the multilingual machine translation model to a pruning threshold to determine whether an entry of the pruning mask will be set to one or zero; and training the multilingual machine translation model, while applying the pruning mask to the multilingual machine translation model, for translation between a language pair based on training examples from a bilingual translation corpus. In this aspect, the respective score of a weight of the multilingual machine translation model may be determined based on a product of the training gradient for the weight and the weight. For example, this aspect could be implemented using other software 318 running on the application server 108.

One aspect of this disclosure is a system, including a processor and a memory, wherein the memory stores instructions executable by the processor to determine respective scores for weights of a multilingual machine translation model based on a training gradient for each weight; determine a pruning mask for the weights of the multilingual machine translation model based on comparing the respective scores of the weights of the multilingual machine translation model to a pruning threshold to determine whether an entry of the pruning mask will be set to one or zero; and train the multilingual machine translation model, while applying the pruning mask to the multilingual machine translation model, for translation between a language pair based on training examples from a bilingual translation corpus. In this aspect, the respective score of a weight of the multilingual machine translation model may be determined based on a product of the training gradient for the weight and the weight. For example, this aspect could include the processor 202 and the memory 204, which may be components of the application server 108.

One aspect of this disclosure is a non-transitory computer-readable storage medium, comprising executable instructions that, when executed by a processor, facilitate performance of operations, including determining respective scores for weights of a multilingual machine translation model based on a training gradient for each weight; determining a pruning mask for the weights of the multilingual machine translation model based on comparing the respective scores of the weights of the multilingual machine translation model to a pruning threshold to determine whether an entry of the pruning mask will be set to one or zero; and training the multilingual machine translation model, while applying the pruning mask to the multilingual machine translation model, for translation between a language pair based on training examples from a bilingual translation corpus. In this aspect, the respective score of a weight of the multilingual machine translation model may be determined based on a product of the training gradient for the weight and the weight. For example, this aspect could include other software 318 accessed by the application server 108.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

That which is claimed is:

1. A method comprising:
determining a pruning mask for weights of a multilingual machine translation model based on a first pruning threshold, wherein the pruning mask includes at least one entry set to zero and at least one entry set to one;
training the multilingual machine translation model, while applying the pruning mask to the multilingual machine translation model, for translation between a language pair based on training examples from a bilingual translation corpus;
updating the pruning mask based on a second pruning threshold; and
training the multilingual machine translation model, while applying the updated pruning mask to the multilingual machine translation model, for translation between the language pair based on training examples from the bilingual translation corpus.

2. The method of claim 1, comprising:
determining the first pruning threshold based on a first pruning ratio that specifies a proportion of the weights of the multilingual machine translation model to be zeroed; and
determining the second pruning threshold based on a second pruning ratio that specifies a proportion of the weights of the multilingual machine translation model to be zeroed.

3. The method of claim 2, wherein the first pruning ratio and the second pruning ratio are interpolated between zero and a target pruning ratio based on a count of iterations of training and updating the pruning mask.

4. The method of claim 1, wherein determining the pruning mask comprises:
comparing magnitudes of the weights of the multilingual machine translation model to the first pruning threshold to determine whether an entry of the pruning mask will be set to one or zero.

5. The method of claim 1, wherein determining the pruning mask comprises:
determining respective scores for the weights of the multilingual machine translation model based on a training gradient for each weight; and
comparing the respective scores of the weights of the multilingual machine translation model to the first pruning threshold to determine whether an entry of the pruning mask will be set to one or zero.

6. The method of claim 5, wherein the respective score of a weight of the multilingual machine translation model is determined based on a product of the training gradient for the weight and the weight.

7. The method of claim 1, wherein the language pair is a first language pair, the pruning mask is a first pruning mask, and further comprising:
determining a second pruning mask for the weights of the multilingual machine translation model based on a third pruning threshold, wherein the second pruning mask includes at least one entry set to zero and at least one entry set to one;
training the multilingual machine translation model, while applying the second pruning mask to the multilingual machine translation model, for translation between a second language pair based on training examples from a second bilingual translation corpus;
updating the second pruning mask based on a fourth pruning threshold; and
training the multilingual machine translation model, while applying the updated second pruning mask to the multilingual machine translation model, for translation between the second language pair based on training examples from the second bilingual translation corpus.

8. A system comprising:
a processor, and
a memory, wherein the memory stores instructions executable by the processor to:
determine a pruning mask for weights of a multilingual machine translation model based on a first pruning threshold, wherein the pruning mask includes at least one entry set to zero and at least one entry set to one;
train the multilingual machine translation model, while applying the pruning mask to the multilingual machine translation model, for translation between a language pair based on training examples from a bilingual translation corpus;
update the pruning mask based on a second pruning threshold; and
train the multilingual machine translation model, while applying the updated pruning mask to the multilingual machine translation model, for translation between the language pair based on training examples from the bilingual translation corpus.

9. The system of claim 8, wherein the memory stores instructions executable by the processor to:
determine the first pruning threshold based on a first pruning ratio that specifies a proportion of the weights of the multilingual machine translation model to be zeroed; and
determine the second pruning threshold based on a second pruning ratio that specifies a proportion of the weights of the multilingual machine translation model to be zeroed.

10. The system of claim 9, wherein the first pruning ratio and the second pruning ratio are interpolated between zero and a target pruning ratio based on a count of iterations of training and updating the pruning mask.

11. The system of claim 8 wherein the memory stores instructions executable by the processor to:
compare magnitudes of the weights of the multilingual machine translation model to the first pruning threshold to determine whether an entry of the pruning mask will be set to one or zero.

12. The system of claim 8, wherein the memory stores instructions executable by the processor to:
determine respective scores for the weights of the multilingual machine translation model based on a training gradient for each weight; and
compare the respective scores of the weights of the multilingual machine translation model to the first pruning threshold to determine whether an entry of the pruning mask will be set to one or zero.

13. The system of claim 12, wherein the respective score of a weight of the multilingual machine translation model is determined based on a product of the training gradient for the weight and the weight.

14. The system of claim 8, wherein the language pair is a first language pair, the pruning mask is a first pruning mask, and the memory stores instructions executable by the processor to:
determine a second pruning mask for the weights of the multilingual machine translation model based on a third pruning threshold, wherein the second pruning mask includes at least one entry set to zero and at least one entry set to one;
train the multilingual machine translation model, while applying the second pruning mask to the multilingual machine translation model, for translation between a second language pair based on training examples from a second bilingual translation corpus;
update the second pruning mask based on a fourth pruning threshold; and
train the multilingual machine translation model, while applying the updated second pruning mask to the multilingual machine translation model, for translation between the second language pair based on training examples from the second bilingual translation corpus.

15. A non-transitory computer-readable storage medium, comprising executable instructions that, when executed by a processor, facilitate performance of operations, comprising:
determining a pruning mask for weights of a multilingual machine translation model based on a first pruning threshold, wherein the pruning mask includes at least one entry set to zero and at least one entry set to one;
training the multilingual machine translation model, while applying the pruning mask to the multilingual machine translation model, for translation between a language pair based on training examples from a bilingual translation corpus;
updating the pruning mask based on a second pruning threshold; and
training the multilingual machine translation model, while applying the updated pruning mask to the multilingual machine translation model, for translation between the language pair based on training examples from the bilingual translation corpus.

16. The non-transitory computer-readable storage medium of claim 15, comprising executable instructions that, when executed by a processor, facilitate performance of operations, comprising:
determining the first pruning threshold based on a first pruning ratio that specifies a proportion of the weights of the multilingual machine translation model to be zeroed; and
determining the second pruning threshold based on a second pruning ratio that specifies a proportion of the weights of the multilingual machine translation model to be zeroed.

17. The non-transitory computer-readable storage medium of claim 16, wherein the first pruning ratio and the second pruning ratio are interpolated between zero and a target pruning ratio based on a count of iterations of training and updating the pruning mask.

18. The non-transitory computer-readable storage medium of claim 15, wherein determining the pruning mask comprises:
comparing magnitudes of the weights of the multilingual machine translation model to the first pruning threshold to determine whether an entry of the pruning mask will be set to one or zero.

19. The non-transitory computer-readable storage medium of claim 15, wherein determining the pruning mask comprises:
determining respective scores for the weights of the multilingual machine translation model based on a training gradient for each weight; and
comparing the respective scores of the weights of the multilingual machine translation model to the first pruning threshold to determine whether an entry of the pruning mask will be set to one or zero.

20. The non-transitory computer-readable storage medium of claim 19, wherein the respective score of a weight of the multilingual machine translation model is determined based on a product of the training gradient for the weight and the weight.
